(19) United States
(12) Patent Application Publication
(10) Pub. No.: US 2015/0222945 A1
(43) Pub. Date: Aug. 6, 2015

(54) SYSTEMS AND METHODS FOR GENERATING A VIDEO COLLECTION

(71) Applicant: INDI.COM, INC., Aliso Viejo, CA (US)

(72) Inventors: John Clarke Jackson, Bethesda, MD (US); Brian Eugene Cunningham, Rockville, MD (US)

(21) Appl. No.: 14/603,183

(22) Filed: Jan. 22, 2015

Related U.S. Application Data
(60) Provisional application No. 61/934,084, filed on Jan. 31, 2014.

(51) Int. Cl. H04N 21/2743; H04N 21/475; H04N 21/61

(52) U.S. Cl. CPC H04N 21/2743; H04N 21/6125; H04N 21/4758

(57) ABSTRACT

Methods and systems for generating a video collection are provided. The method includes presenting a competitive channel for submitting video content via a computing device; creating a challenge to solicit video content from a plurality of users, where the challenge is defined by a plurality of challenge attributes stored at a memory device; accepting one or more videos from at least some of the plurality of users; accepting votes from at least some of the plurality of users to select a subset of the posted videos; and archiving at least some of the posted videos to a video collection accessible via the computing device.

### BACKGROUND

Cross-reference to Related Application: This application claims priority under 35 §USC 119 (e) to the U.S. Provisional Patent Application, Ser. No. 61/934,084 filed on Jan. 31, 2014, the disclosure of which is incorporated herein by reference in its entirety.

1. Technical Field

The various aspects disclosed herein are generally related to network communications and more particularly to generating a video collection.

2. Related Art

Electronically archived video collections can be found on a variety of different Internet websites such as YouTube® and others (without derogation of any trademark rights). On such platforms, visitors may be able to post a video to which they may or may not hold the copyrights. Furthermore, collecting videos that have a common genre and storing only those videos that have artistic or other useful merit can be a difficult task to manage. Also, soliciting the submission of videos having significant artistic merit or production quality and which may have relevance to a particular target audience has also proven difficult. Continuous efforts are being made for better managing videos.

### SUMMARY

In one aspect, a machine implemented method is provided. The method includes includes presenting a competitive channel for submitting video content via a computing device; creating a challenge to solicit video content from a plurality of users, where the challenge is defined by a plurality of challenge attributes stored at a memory device; accepting one or more videos from at least some of the plurality of users; accepting votes from at least some of the plurality of users to select a subset of the posted videos; and archiving at least some of the posted videos to a video collection accessible via the computing device.

In another aspect, a non-transitory, machine readable storage medium having stored thereon instructions for performing a method is provided. The machine executable code which when executed by at least one machine, causes the machine to: present a competitive channel for submitting video content via a computing device; create a challenge to solicit video content from a plurality of users, where the challenge is defined by a plurality of challenge attributes stored at a memory device; accept one or more videos from at least some of the plurality of users; accept votes from at least some of the plurality of users to select a subset of the posted videos; and archive at least some of the posted videos to a video collection accessible via the computing device.

In yet another aspect, a memory containing machine readable medium comprising machine executable code having stored thereon instructions is provided. A processor module coupled to the memory is configured to execute the machine executable code to: present a competitive channel for submitting video content via a computing device; create a challenge to solicit video content from a plurality of users, where the challenge is defined by a plurality of challenge attributes stored at a memory device; accept one or more videos from at least some of the plurality of users; accept votes from at least some of the plurality of users to select a subset of the posted videos; and archive at least some of the posted videos to a video collection accessible via the computing device.

This brief summary has been provided so that the nature of this disclosure may be understood quickly. A more complete understanding of the disclosure can be obtained by reference to the following detailed description of the various aspects thereof in connection with the attached drawings.

### BRIEF DESCRIPTION OF THE DRAWINGS

The various aspects of the present disclosure now will be discussed in detail with an emphasis on highlighting the advantageous features. These aspects depict the novel and non-obvious systems and methods for packet grouping in networks shown in the accompanying drawings, which are for illustrative purposes only. These drawings include the following figures, in which like numerals indicate like parts:

FIG. 1 is a block diagram of a computing environment in which the present aspects may be used;

FIG. 2 shows a block diagram of a video collection system operating in a networked computing environment, according to one aspect of the present disclosure; and

FIGS. 3 and 4 show various process flow diagrams according to the various aspects of the present disclosure.

### DETAILED DESCRIPTION

The following detailed description describes the present aspects with reference to the drawings. In the drawings, reference numbers label elements of the present aspects. These reference numbers are reproduced below in connection with the discussion of the corresponding drawing features.

As a preliminary note, any of the aspects described with reference to the figures may be implemented using software, firmware, hardware (e.g., fixed logic circuitry), or a combination of these implementations. The terms “logic,” “module,” “component,” “system” and “functionality,” as used herein, generally represent software, firmware, hardware, or a combination of these elements. For instance, in the case of a software implementation, the terms “logic,” “module,” “component,” “system,” and “functionality” represent program code that performs specified tasks when executed on a processing device or devices (e.g., CPU or CPUs). The program code can be stored in one or more computer readable memory devices.

More generally, the illustrated separation of logic, modules, components, systems, and functionality into distinct units may reflect an actual physical grouping and allocation of software, firmware, and/or hardware, or can correspond to a conceptual allocation of different tasks performed by a single software program, firmware program, and/or hardware unit. The illustrated logic, modules, components, systems, and functionality may be located at a single site (e.g., as implemented by a processing device), or may be distributed over a plurality of locations.

The term “machine-readable media” and the like refers to any kind of non-transitory medium for retaining information in any form, including various kinds of storage devices (magnetic, optical, static, etc.). The aspects disclosed herein, may be implemented as a computer process (method), a computing system, or as an article of manufacture, such as a computer program product or a non-transitory, computer-readable media. The computer program product may be non-transitory, computer storage media, readable by a computer device, and encoding a computer program of instructions for executing a computer process.

The systems and processes described below are applicable and useful in the upcoming cloud computing environment. Cloud computing pertains to computing capability that provides an abstraction between the computing resource and its underlying technical architecture (e.g., servers, storage, networks), enabling convenient, on-demand network access to a shared pool of configurable computing resources that can be rapidly provisioned and released with minimal management effort or service provider interaction. The term “cloud” is intended to refer to the Internet and cloud computing allows shared resources, for example, software and information, to be available, on-demand, like a public utility.

Typical cloud computing providers deliver common applications online, which are accessed from another web service or software like a web browser, while the software and data are stored remotely on servers. The cloud computing architecture uses a layered approach for providing application services. A first layer is an application layer that is executed at client computers. In this example, the application allows a client to access storage via a cloud. After the application layer is a cloud platform and cloud infrastructure, followed by a “server” layer that includes hardware and computer software designed for cloud-specific services.

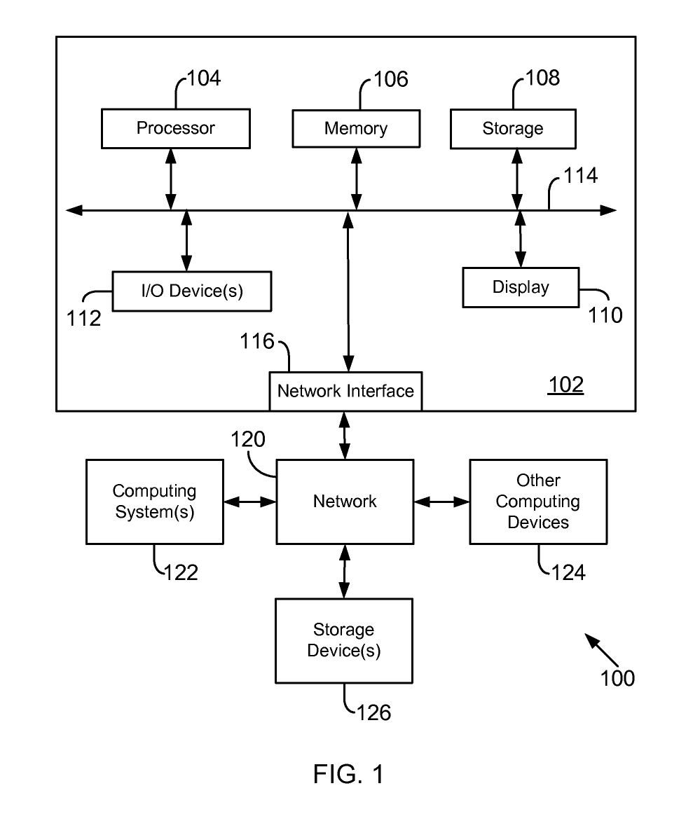

System 100: FIG. 1 shows an example of a system 100 that may be used in connection with the present aspects. System 100 may include a computing system 102, which may be referred to as a host system. A typical host system 102 includes several functional components, including a central processing unit (CPU) (also referred to as a processor, processors or processing module) 104, a host memory (or main/system memory) 106, a storage device 108, a display 110, input/output (“I/O”) device(s) 112, and other components (or devices). The host memory 106 is coupled to the processor 104 via a system bus or a local memory bus 114.

The processor 104 may be, or may include, one or more programmable general-purpose or special-purpose microprocessors, digital signal processors (DSPs), programmable controllers, application specific integrated circuits (ASICs), programmable logic devices (PLDs), or the like, or a combination of such hardware-based devices.

The host memory 106 provides the processor 104 access to data and program information that is stored in the host memory 106 at execution time. Typically, the host memory 106 includes random access memory (RAM) circuits, read-only memory (ROM), flash memory, or the like, or a combination of such devices.

The storage device 108 may comprise one or more internal and/or external mass storage devices, which may be or may include any conventional medium for storing data in a non-volatile manner. For example, the storage device 108 may include conventional magnetic disks, optical disks such as CD-ROM or DVD-based storage, magneto-optical (MO) storage, flash-based storage devices, or any other type of non-volatile storage devices suitable for storing structured or unstructured data.

The host system 102 may also include a display device 110 capable of displaying output, such as an LCD or LED screen and others, and one or more input/output (I/O) devices 112, for example, a keyboard, mouse, etc. The host system 102 may also include other devices/interfaces for performing various functions, details of which are not germane to the inventive aspects described herein.

The host system 102 also includes a network interface 116 for communicating with other computing systems 122, storage devices 126 and devices 124 via a network 120. Network interface 116 may include a processor, memory and a plurality of ports (not shown). The ports are used to receive and send information, while the processor (not shown) executes firmware instructions out of the memory (not shown).

Network 120 may be a local area network (LAN), a wide area network (WAN) or the Internet. The aspects disclosed herein are not limited to any network type. Computing devices 124 may include laptops, smart phones, tablets or other mobile devices. Computing systems 122 and devices 124 may be used by users to upload videos and votes, as described below in detail.

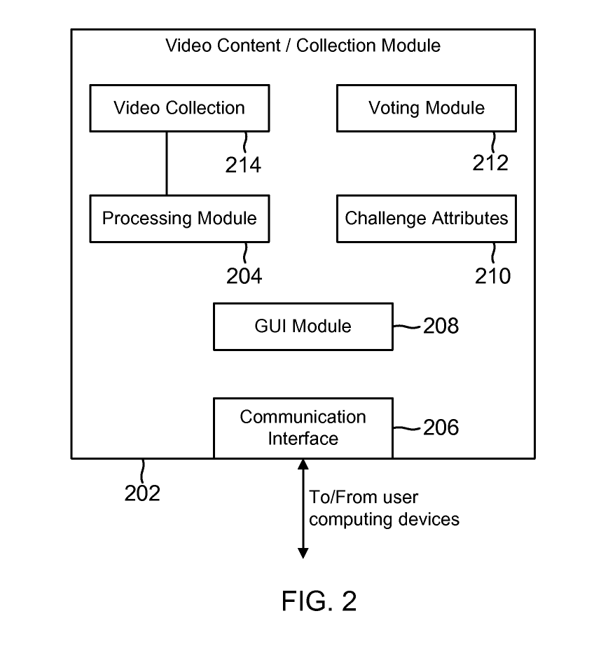

In one aspect, the processor 104 of the host system 102 may execute various applications, for example, a video content and collection module (or system) 202 (may also be referred to as module 202 or system 202) (FIG. 2), an e-mail server application, databases, and other application types. System 202 is described below in detail with respect to FIG. 2.

System 202: FIG. 2 illustrates a functional block diagram of system 202 executed by the processor 104 out of memory 106 of host system 102. Components of the system 202 include a video collection module 214 coupled to a processing module 204, a voting module 212, a challenge attributes module 210, a graphics user interface (GUI) module 208 and a communications interface 206. The GUI module 208 provides a web-based user interface to users for submitting videos via a computing device as well as for voting. Communication interface 206 may be used to send and receive data via network interface 116.

It is noteworthy that certain modules of system 202 may be implemented in hardware, software or a combination thereof. Furthermore, the various modules may be implemented in a distributed environment, where one module is implemented at host system 102 and another module is implemented at another computing system.

System 202 may be used for issuing a “challenge” to solicit videos from contestants, i.e. users of the system 202 via network 120. The users may be either the public at large who have created a user account within the system 202 or a selected group of contestants/users, which have created user accounts. The aspects described herein may be implemented without user accounts.

The system 202 may initiate a challenge having a plurality of challenge attributes 210 that are stored in a data structure at a memory location (for example, 106). The challenge attributes 210 may include any number of parameters for initiating a contest, such as a title of the challenge or contest, an image that illustrates the challenge, a written description that describes the challenge, a video introduction to the subject matter of the contest, potential prizes for a winner or winners of the challenge, a minimum or maximum video length in terms of time and/or megabytes, identification of any judges for the videos as well as any notes or rules on how the contest will be judged, a preview date, dates on which video submissions may start and/or end, and dates on which voting to select the best videos may start and/or end. Compliance with the challenge attributes 210 encourages video submissions with higher production quality and relevance to a particular audience, demographic, advertising or other purpose.

In order for a contestant to enter or upload a video for the competition, the contestant may create or have a user account. This can be accomplished by accessing system 202 via a GUI. At which time the contestant may be asked to create an account having a user name and a password to prevent other unauthorized visitors from accessing the account and posting and/or deleting videos without the account holder's knowledge and/or permission. The user account may also include a profile that may include such information as mailing address, phone number and email address of the contestant/user. Before submitting a video for a particular contest, the contestant may have to agree to the rules of the challenge, by for example checking an agreement box at the completion of a recitation of the challenge rules. Upon such agreement, the contestant may submit or post a video for the contest that complies with the rules of the challenge.

The challenge attributes 210 may also include a validation token. The validation token provides a mechanism for the contestant to certify that the content of any video submitted is a work of the account holder's own authorship and does not violate copyright(s) of others. An administrator of the system 202 and/or the judges shall have the authority to determine whether the above conditions have been satisfied and whether a submitted video conforms to the rules.

The voting module 212 oversees voting regarding video submissions, according to one aspect. A voting period during which public users (i.e. unregistered visitors to the website/system), registered users and/or judges (as the challenge rules may dictate) may download or view videos and then vote to select, rate, rank and/or share the submitted videos for a given contest. Sharing may include dissemination of one or more submitted videos and/or a link or links to download or view such submitted videos by email, instant messaging, text message, social networks (such as Facebook® or Twitter® (without derogation of any third party trademark rights) or other means. Multiple methods of voting may be allowed in the same challenge/contest. The voting module 212 may operate under several different schemes, depending on a particular challenge as programmed into the system 202.

The following are possible voting criteria: (i) each voter may get one and only one vote per challenge/contest; (ii) each voter may get one vote per video per challenge; (iii) each voter may get one vote for a particular time period per challenge, e.g. for a challenge lasting three days, a voter may get one vote per day or three votes in total; (iv) each voter may get one vote per video per time period for the challenge; or (v) each voter may get an unlimited number of votes per challenge/contest.

Once the voting period has concluded, the voting module 212 may tabulate the votes and provide data to the processing module 204. To the extent that multiple methods of voting are allowed in a challenge/contest, certain methods of voting may have more or less weight than other methods in the tabulation of the final vote count or score. Other factors, such as the number of views or downloads that a video received during the challenge/contest may be included in the tabulation of the final vote count or score. Additionally, votes by certain classes of users (such as unregistered visitors to the website/system, registered users or judges) may have more or less weight than votes by other classes of users in the tabulation of the final vote count or score. The results may be provided to the voting public that could include (i) rank of the videos in order of most votes cast or highest score, e.g. first place, second place, etc.; (ii) rank of the videos according to the votes cast by only the judges; (iii) identification of featured videos, e.g. particularly unusual, unique or high-quality videos; or (iv) videos that were the most viewed, but did not necessarily garner the most votes.

Upon completion of the challenge, the videos may be stored by the video collection 214 at a storage device (108). The collection 214 may be cataloged and indexed in any number of ways by the processing module 204. For example, the collection may be cataloged by title, by content, by date of the contest, or any other number of criteria.

System 202 may be used as a stand-alone application, e.g. a dedicated website, or may be integrated into another application having functions in addition to those of submitting, voting, and collecting videos. The content associated with the video collection 214 may be redistributed through other mediums such as, for example, television, DVD, and digital libraries/stores such as iTunes®.

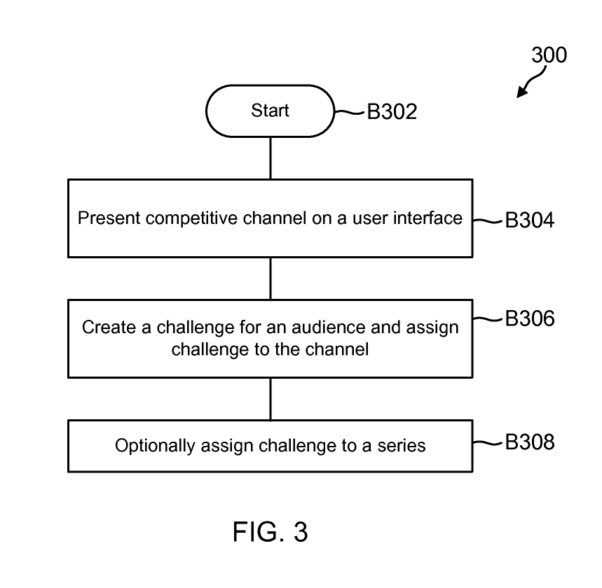

Process Flow: FIG. 3 illustrates a process 300 for using system 202, according to one aspect. The process begins in B302, when host system 102 is operational and system 202 is initialized. A competitive channel is presented on a computing device (for example, 122, FIG. 1) via a user interface in B304. As an example, the competitive channel for a particular challenge could be a dedicated page on a website, a link and/or icon, or an option on a website drop down pick list. The competitive channel may be of any type, for example, cooking, sports or any other activity.

In B306, a challenge is created including the identification of the challenge attributes for a particular contest. The challenge is assigned to the channel created in the previous step. Optionally, in B308, the challenge may be assigned to a series of similar challenges based on subject matter. For example, if the subject matter pertains to videos relating to cooking, there may be one or more series related to various ethnic cooking contests, e.g. Italian, French, Mexican, etc. or one or more series related to courses in a meal, e.g. soup, salad, entrée, desert, etc. The challenge may be for example, a best pasta recipe.

The challenge may be represented graphically by a title, image or both. The challenge may be defined by a title, image, description, video introduction, director notes, prizes, minimum video length, maximum video length, guest judges, preview data, submission start date, submission end date, voting end date and challenge rules. The challenge rules may include that the video should include a specific word, phrase or a graphical/visual representation of a specific word, phrase, symbol or object as a validation token. The validation token may be used to validate a video to ensure that intellectual property rights of others is not infringed. The challenge rules are stored as part of the challenge attributes 210 described above.

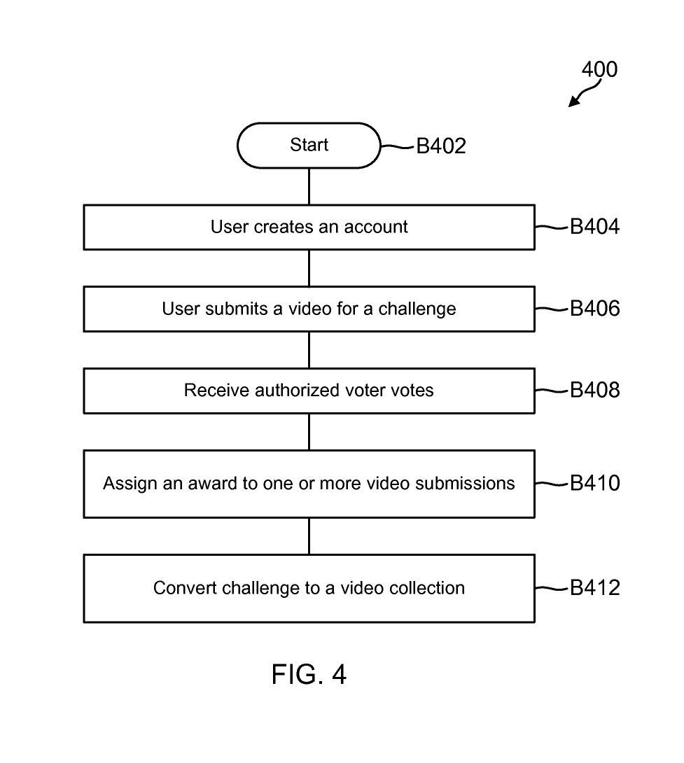

FIG. 4 illustrates another process flow diagram 400 for using system 202, according to one aspect of the present disclosure. The process begins in B402, when system 202 is operational. In B404, a user/contestant creates an account as previously described above. The system 202 confirms that the account was properly created, by for example, sending a confirmation email to the user's email address on file. Alternatively, a user can sign into an account that they have already created in a previous session, for example.

In B406, the user/contestant submits a video for a challenge/contest that was created previously, as for example, in B306. The system 202 ascertains that the submitted video conforms and complies with all challenge attributes 210 relevant to the contest. As mentioned above, the challenge attributes 210 may be stored at a storage device. The attributes of the submitted video are compared to the stored attributes to determine compliance or non-compliance. If the submitted video is compliant, the system 202 sends the contestant an acknowledgement (as a validation token). If the submitted video is not compliant, the system 202 sends the contestant an error message. After the period for contestants to post videos expires, the system 202 activates the voting module 212. The rules for voting are posted, on the system's website for example.

In B408, voting may begin by those authorized to vote. The voting may be once per voter per challenge, once per voter per video per challenge, once per voter per time period per challenge, once per voter per video per time period per challenge or any other way. Upon completion of the voting, in B410, the voting module 212 tabulates the votes according to preset criteria, posts the results of the voting on the website or other location and assigns awards to one or more submitted videos as the contest rules may dictate. For example, the award may be based on a voting rank, judges pick, featured video, and most reviewed rank or other criteria. Then, in B412, all or some of the submitted videos for a particular contest are archived and converted into the video collection 214. Thus the video collection 214 may include videos of high performance, quality and/or relevance to a particular audience or purpose defined by the challenge.

In one aspect, a contest format is used to create a video collection that is useful to users. In another aspect, a validation scheme is used to ensure that the submitted does not violate any third party rights.

The above description presents the best mode contemplated for carrying out the various aspects of the present disclosure, and of the manner and process of making and using it, in such full, clear, concise, and exact terms as to enable any person skilled in the art to which it pertains to make and use the adaptive techniques described herein. This aspects described herein are, however, susceptible to modifications and alternate constructions from that discussed above that are fully equivalent. Consequently, this various inventive aspects described herein are not limited to the foregoing disclosure. On the contrary, this disclosure covers all modifications and alternate constructions coming within the spirit and scope of the inventive aspects as generally expressed by the following claims, which particularly point out and distinctly claim the subject matter of the inventive aspects.

What is claimed is:

1. A machine implemented method, comprising:
presenting a competitive channel for submitting video content via a computing device;
creating a challenge to solicit video content from a plurality of users, where the challenge is defined by a plurality of challenge attributes stored at a memory device;
accepting one or more videos from at least some of the plurality of users;
accepting votes from at least some of the plurality of users to select a subset of the posted videos; and
archiving at least some of the posted videos to a video collection accessible via the computing device.

2. The method of claim 1, further comprising assigning an award to at least one of the posted videos based on the accepted votes.

3. The method of claim 2, wherein the accepted votes are weighted based on a type of user for each user submitting a vote.

4. The method of claim 1, wherein accepting one or more videos comprises comparing attributes of each video to the stored plurality of challenge attributes; and accepting only the one or more videos whose attributes comply with the challenge attributes.

5. The method of claim 1, further comprising checking whether a user is authorized to vote before accepting votes from the user.

6. The method of claim 1, wherein the presenting a competitive channel is done on a website accessible through a network.

7. The method of claim 6, where in the network is the Internet.

8. A non-transitory, machine readable storage medium having stored thereon instructions for performing a method, comprising machine executable code which when executed by at least one machine, causes the machine to:
present a competitive channel for submitting video content via a computing device;
create a challenge to solicit video content from a plurality of users, where the challenge is defined by a plurality of challenge attributes stored at a memory device;
accept one or more videos from at least some of the plurality of users;
accept votes from at least some of the plurality of users to select a subset of the posted videos; and
archive at least some of the posted videos to a video collection accessible via the computing device.

9. The storage medium of claim 8, wherein the machine executable code further causes the machine to: assign an award to at least one of the posted videos based on the accepted votes.

10. The storage medium of claim 9, wherein the accepted votes are weighted based on a type of user for each user submitting a vote.

11. The storage medium of claim 8, wherein accepting one or more videos comprises comparing attributes of each video to the stored plurality of challenge attributes; and accepting only the one or more videos whose attributes comply with the challenge attributes.

12. The storage medium of claim 8, wherein the machine executable code further causes the machine to check whether a user is authorized to vote before accepting votes from the user.

13. The storage medium of claim 8, wherein the presenting a competitive channel is done on a website accessible through a network.

14. A system comprising:
a memory containing machine readable medium comprising machine executable code having stored thereon instructions; and
a processor module coupled to the memory, the processor module configured to execute the machine executable code to:
present a competitive channel for submitting video content via a computing device;
create a challenge to solicit video content from a plurality of users, where the challenge is defined by a plurality of challenge attributes stored at a memory device;
accept one or more videos from at least some of the plurality of users;
accept votes from at least some of the plurality of users to select a subset of the posted videos; and
archive at least some of the posted videos to a video collection accessible via the computing device.

15. The system of claim 13 further comprising code to: assign an award to at least one of the accepted videos based on the accepted votes.

16. The system of claim 14 wherein the accepted votes are weighted based on a type of user for each user submitting a vote.

17. The system of claim 13 wherein the code to accept one or more videos comprises code to:
compare attributes of each video to the plurality of stored challenge attributes associated with the challenge; and
accepting only the one or more videos whose attributes comply with the challenge attributes.

18. The system of claim 13 wherein the presenting a competitive channel is done on a website accessible through the network.

19. The system of claim 17 wherein the network comprises the Internet.
